(19) United States
(12) Patent Application Publication
(10) Pub. No.: US 2012/0239469 A1
(43) Pub. Date: Sep. 20, 2012

(54) SYSTEM AND METHOD FOR MARKETING

(75) Inventors: Deena Edit Steinberg, Netanya (IL); Michal Hubschmann, Amstelveen (NL)

(73) Assignee: Videodeals.com S.A., Luxembourg (LU)

(21) Appl. No.: 13/328,889

(22) Filed: Dec. 16, 2011

Related U.S. Application Data
(60) Provisional application No. 61/453,038, filed on Mar. 15, 2011.

(51) Int. Cl. G06Q 30/02

(52) U.S. Cl. 705/14.4; 705/26.1; 705/27.1

(57) ABSTRACT

Exemplary methods and systems to display advertising content are disclosed. In an embodiment, a method of creating content with embedded advertisements includes creating content, receiving tools to embed advertisements within the content, creating one or more activation zones within the content, linking each of the one or more activation zones to at least one product in at least one link, linking the one or more activation zones with a checkout system, wherein the activation zones and the links to the at least one product and the one or more checkout systems comprise association data, and providing the content and the association data to a publishing system.

### CROSS-REFERENCE TO RELATED APPLICATIONS

This application claims priority to co-pending U.S. Provisional Patent Application No. 61/453,038, filed Mar. 15, 2011, the entire disclosure of which is incorporated herein by reference.

### BACKGROUND

Content, particularly video content such as commercials or other advertisement, is passive and does not engage a consumer or user. The user, upon viewing video content showing advertisements, must then visit the advertiser's site or store, and select the product or products shown in the video content. Also, non-advertisement video content, such as a television show or home movie, does not display advertisements. A user must view the video content and then attempt to determine which products were shown and where the products may be available.

### SUMMARY

In an exemplary embodiment of the present disclosure, a method of creating content with embedded advertisements is provided. The method comprises the steps of creating content, receiving tools to embed advertisements within the content, creating one or more activation zones within the content, linking each of the one or more activation zones to at least one product in at least one link, linking the one or more activation zones with a checkout system, wherein the activation zones and the links to the at least one product and the one or more checkout systems comprise association data, and providing the content and the association data to a publishing system.

In another exemplary embodiment of the present disclosure, an publishing system is provided. The publishing system includes a portal available to advertisers to create and edit the one or more items of content, a module operable to receive and store one or more items of content transmitted from the portal, a module operable to embed one or more activation zones and associate one or more items with the content and the activation zones as association data, a module to transmit the content and the association data to a client, a module to receive purchase requests from the client and activate a checkout process, a module to generate statistical information regarding a user's interaction with the content, and a module to transmit information regarding one or more of the one or more items of content to a social networking system.

In yet another exemplary embodiment of the present disclosure, a method of creating content with embedded advertisements is provided. The method includes creating content, receiving tools to embed advertisements within the content, creating one or more activation zones within the content, linking each of the one or more activation zones to at least one product in at least one link, linking the one or more activation zones with a checkout system, wherein the activation zones and the links to the at least one product and the one or more checkout systems comprise association data, and providing the content and the association data to a publishing system.

In yet another exemplary embodiment of the present disclosure, a method of advertising products in content is provided. The method includes receiving content with one or more activation zones, wherein each of the activation zones include at link to at least one product identifier, wherein the product identifiers identify at least one product, transmitting the content to a client, receiving a purchase request from the client with one or more product identifiers, transmitting a checkout screen to the client, the checkout screen indicating a purchase of at least one product associated with the one or more product identifiers, and transmitting purchase information to an advertiser associated with the product associated with the one or more product identifiers.

Additional features and advantages of the present disclosure will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the attendant advantages of the present disclosure will become more readily appreciated as the same become better understood by reference to the following detailed description when taken in conjunction with the accompanying drawings.

FIG. 1 shows a component view of a publishing system and other components according to an embodiment of the present disclosure.

FIG. 2 shows a component view of the publishing system according to an embodiment of the present disclosure.

FIG. 3 shows a method of making content available according to an embodiment of the present disclosure.

FIG. 4 shows a method of receiving a selection for content and displaying content and advertisement according to an embodiment of the present disclosure.

FIG. 5 shows an exemplary start screen according to an embodiment of the current disclosure.

FIG. 6 shows a screen with an exemplary set of categories according to an embodiment of the present disclosure.

FIG. 7 shows a screen with an exemplary set of popular videos according to an embodiment of the present disclosure.

FIG. 8 shows an exemplary screen of last minute deals according to an embodiment of the present disclosure.

FIG. 9 shows a screen with an exemplary user profile according to an embodiment of the present disclosure.

FIG. 10 shows an exemplary screen allowing a user to invite friends according to an embodiment of the present disclosure.

FIG. 11 shows a screen requesting a user give permission for a site to access the user's information according to an embodiment of the present disclosure.

FIG. 12 shows a screen with an exemplary user's location on a map according to an embodiment of the present disclosure.

FIG. 13 shows a screen with an exemplary list of favorite videos, showing three different video display options according to an embodiment of the present disclosure.

FIG. 14 shows a screen with an exemplary video with an advertisement overlaid on the video which is displayed during a mouseover event on the specific item for sale, where clicking on the advertisement leads to a shopping cart, a set of products below the video, and one or more coupons beside the video according to an embodiment of the present disclosure.

FIG. 15 shows a screen with an exemplary video with an advertisement overlaid on the video which is displayed during a mouseover event on the specific item for sale, where clicking on the advertisement leads to a shopping cart, and a product overlaid on the video, where clicking on the product leads to a shopping cart according to an embodiment of the present disclosure.

FIG. 16 shows a screen with an exemplary advertisement overlaid on an exemplary video according to an embodiment of the present disclosure.

FIG. 17 shows a screen with an exemplary account data entry and purchase screen after the user selected an advertisement on the exemplary video of FIGS. 15-17 according to an embodiment of the present disclosure.

FIG. 18 shows a screen with an exemplary video with an advertisement overlaid on the video and a selector to change the color of a product in the video according to an embodiment of the present disclosure.

FIG. 19 shows a screen with an exemplary slideshow with embedded advertisements according to an embodiment of the present disclosure.

FIG. 20 shows an exemplary screen indicating exemplary social media outlets and outlets to mobile broadcasting facilities for sharing one or more items of content according to an embodiment of the present disclosure.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of a publishing system and methods for publishing, purchasing, and presenting advertisements in videos and images, it should be understood that the concepts presented herein may be used in other various configurations consistent with this disclosure.

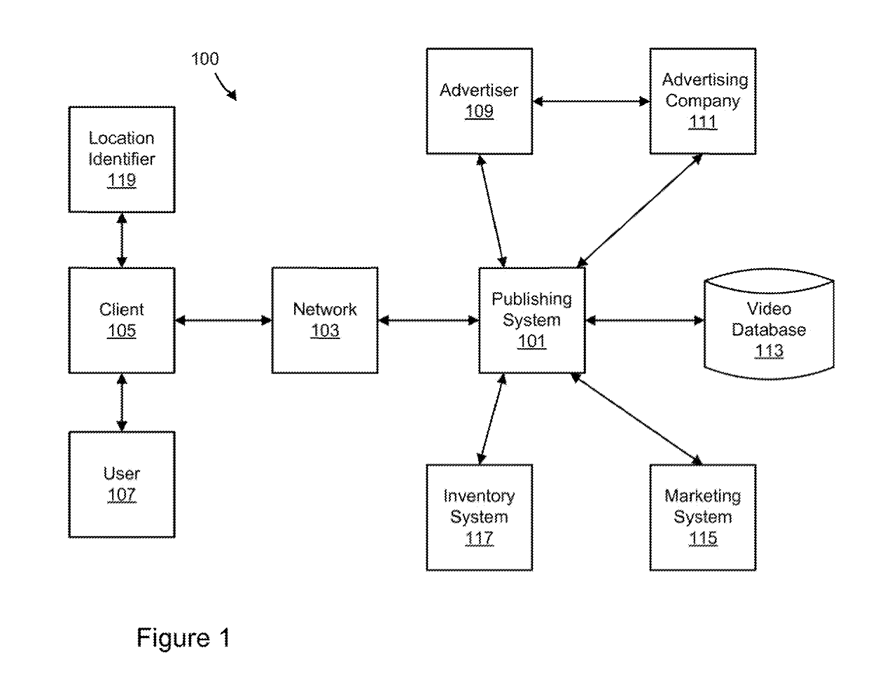

FIG. 1 shows a component view of a publishing system 101 and other components according to an embodiment of the present disclosure. In the embodiment, a user 107 communicates with a client 105. The client 105 may use one or more signals from a location identifier 119 to determine the location of the client 105, and may transmit the location information and/or additional user 107 commands to the publishing system 101. The adverting system may receive the signals from the client 105, and may access content stored on a video database 113, or may communicate with one or more advertisers 109, one or more advertising companies 111, one or more inventory systems 117, and/or one or more marketing systems 115.

The user 107 interacts with the client 105 to send and receive information from the publishing system 101. In an embodiment, the client 105 communicates with the publishing system 101 via one or more networks 103. In an embodiment, the user 107 may create content or modify existing content, and may upload the content to the publishing system 101 or link to the content hosted by the user 107 or by a third party. The user 107 may, in an embodiment, create content that is linked to products sold by an advertiser 109, so that the user 107 or other users may purchase content provided by the advertiser 109 when viewing the content.

The client 105 allows the user 107 to send information to and receive information from the publishing system 101 and/or other computer systems, such as, for example and without limitation, the inventory system 117, the marketing system 115, the advertiser 109, or the advertising company 111. The client 105 may communicate with the publishing system 101 and/or other computer systems via the network 103, or may communicate with the publishing system 101 and/or other computer systems via another connection. The client 105 may include a receiver to receive signals from the location identifier 119 to calculate or receive an approximate or exact location of the client 105 and/or the receiver.

In an embodiment, the client 105 is a desktop or laptop computer that is connected to a network 103 to communicate with the publishing system 101. The user 107 may interact with the desktop or laptop computer to send commands and information to the publishing system 101, and receive information or commands from the publishing system 101. In an embodiment, the client 105 may be a tablet or other portable computer system. In an embodiment, the client 105 may be one or more virtual machines operating on a server computer system. In an embodiment, the client 105 may be another form of thin client computer system. In an embodiment, the client 105 is, for example and without limitation, a smartphone or other electronic device equipped with a global positioning system (“GPS”) device used to identify the device's location. Software and/or hardware may be installed on the smartphone to allow the smartphone to capture location information and/or additional commands or inputs, and transmit the location information and/or additional commands or inputs to the network 103. The smartphone or other device may communicate with the publishing system 101 via the network 103 while the smartphone or other device is moving. In another embodiment, the client 105 may be a television or radio that receives signals from the publishing system 101 or another system, and displays the signals for the user 107. The television may also receive signals from the user 107 via, for example and without limitation, a remote control or other device, and may transmit the signals to the publishing system 101.

The location identifier 119, in some embodiments, assists the client 105 and/or the publishing system 101 in determining location. The location identifier 119 may be, for example and without limitation, a global positioning system device that sends signals to a receiver in communication with the client 105 and/or the publishing system 101, one or more transmitters or receivers to determine an approximate location, such as by radio triangulation, astronomical location, or other methods to determine an approximate point of location. In an embodiment, the location identifier 119 also includes other global positioning satellite systems, or may use one or more global navigation satellite systems and/or other methods of location identification to refine or augment location information. In an embodiment, the location identifier 119 uses two or more of the exemplary devices listed above to determine location.

The network 103 may include one or more of: a local area network, a wide area network, a radio network such as a radio network using an IEEE 802.11x communications protocol, a cellular network, a satellite network, a cable network, a fiber network or other optical network, a token ring network, or any other kind of packet-switched or direct transmission network may be used. In an embodiment, the network 103 includes the Internet. In an embodiment, the network 103 includes any other type of public or private network. The use of the term “network” does not limit the network to a single style or type of network, or imply that one network is used. A combination of networks of any communications protocol or type may be used. For example, two or more packet-switched networks may be used, or a packet-switched network may be in communication with a radio network.

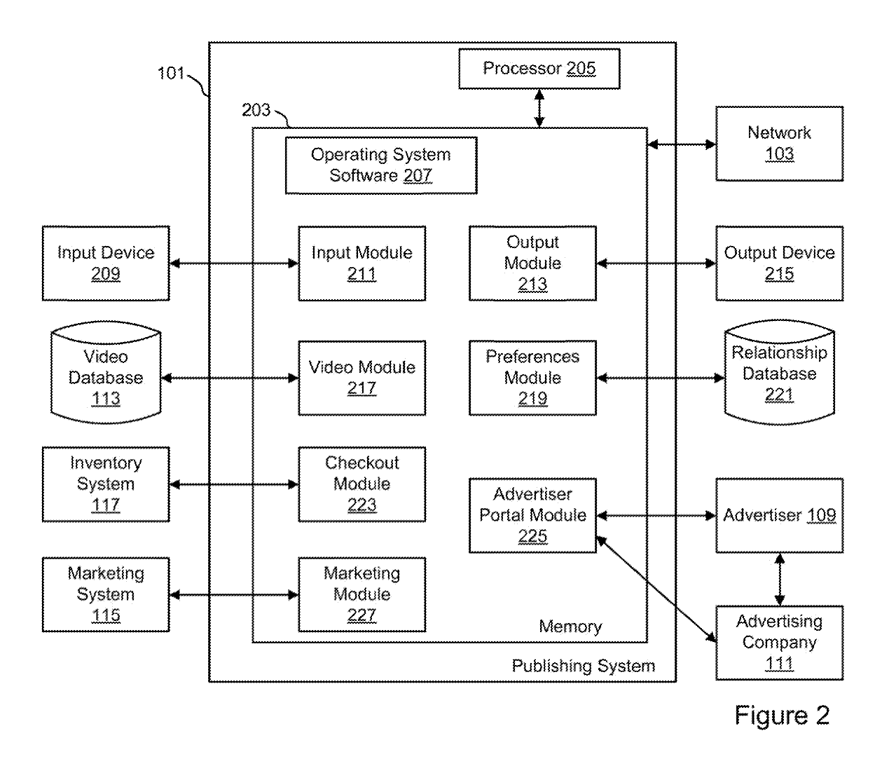

The publishing system 101, also described with reference to FIG. 2, below, receives instructions from the client 105 through one or more networks 103 or through direct connection to the client 105. The publishing system 101 may include a computer system with one or more processors 205 to retrieve and/or store content with the video database 113, interact with the inventory system 117, interact with the marketing system 115, interact with the advertiser 109, and provide content and interact with the user 107 via the client 105. In an embodiment, the publishing system 101 interacts with a plurality of users via a plurality of clients 105, and may transmit content from the video database 113 or other location to multiple clients 105 at the same time or substantially the same time.

The video database 113 stores and recalls the content provided by the user 107, the publishing system 101, the advertiser 109, and/or the advertising company 111. In an embodiment, the video database 113 uses an object oriented and relational database to store the video, metadata, and/or the data. In another embodiment, the video database 113 uses other structures to store the data. For example, the video database 113 may include data stored in an object-based data structure, a hierarchical data structure, a flat file data structure, or another type of data structure that may allow the storage and recall of data. In an embodiment, the video database 113 operates on the same system or group of systems on which the publishing system 101 operates as, for example and without limitation, a separate electronic process or processes. In another embodiment, the video database 113 operates on a system that is separate from the publishing system 101, and the publishing system 101 and the video database 113 are in communication via, for example and without limitation, one or more networks 103 or one or more dedicated connections.

The advertiser 109 may include one or more computer systems that may allow an advertiser to create content and upload the content to the publishing system 101, or to communicate with the publishing system 101 to allow the publishing system 101 access to content that is hosted by the advertiser 109 or by a third party. The advertiser 109 may also retrieve information from the publishing system 101 related to the content that the advertiser 109 has provided. For example, and without limitation, the publishing system 101 may track the number of users who have viewed the content that the advertiser 109 has uploaded to the publishing system 101, or the amount of product purchased by one or more users from the content uploaded to the publishing system 101 or hosted by the advertiser 109 or one or more third parties. The advertiser 109 may, for example, be given or may create a unique identifier to authenticate the advertiser 109 to the publishing system 101. In an embodiment, for example and without limitation, the unique identifier includes a username and password combination. In another embodiment, the unique identifier may include other information that uniquely identifies an advertiser 109 to the publishing system 101. The advertiser 109 may interact with the publishing system 101 via, for example and without limitation, a separate portal from the user 107, so that the advertiser 109 and the user 107 may have access to different information. In an embodiment, the user 107 may also be an advertiser 109, or an advertiser 109 may also be a user 107. The advertiser 109 may be in communication with the publishing system 101 and/or the advertising company 111 via a network, such as network 103 or a network separate from network 103, or may be in communication via a dedicated connection. The advertiser 109 or user 107 may, for example and without limitation, upload a video recorded from the video functionality of a smartphone, or from another video and/or audio recorder. In an embodiment, an application may be provided for a smartphone or other device so that coupons or other deals may be associated with the content before it is uploaded to the publishing system 101.

The advertising company 111 may be a third party, or may be associated with the advertiser 109, and may create or enhance content from an advertiser 109 for the publishing system 101. The advertising company 111 may transmit content to the advertiser 109, or the advertising company 111 may transmit content to the publishing system 101 on behalf of an advertiser 109. In an embodiment, the advertising company 111 may upload content to the publishing system 101, or the advertising company 111 may provide information to allow the publishing system 101 access to content that is hosted by the advertising company 111 or a third party. In an embodiment, the advertising company 111 may be given or may create a unique identifier to authenticate the advertising company 111 to the publishing system 101. In an embodiment, for example and without limitation, the unique identifier includes a username and password combination. In another embodiment, the unique identifier may include other information that uniquely identifies an advertising company 111 to the publishing system 101. The advertiser 109 may interact with the publishing system 101 via, for example and without limitation, a separate portal from the user 107, so that the advertising company 111 and the advertiser 109 working with the advertising company 111 have access to different sets of information from the publishing system 101. For example, the publishing system 101 may allow an advertising company 111 to upload content to the publishing system 101 on behalf of an advertiser 109, but may not allow the advertising company 111 to view statistical information that the publishing system 101 gathers on the content. The statistical information, in the embodiment, is limited to the advertiser 109. In an embodiment, the statistical information is shared with both the advertiser 109 and the advertising company 111.

The inventory system 117 is in communication with the publishing system 101. In an embodiment, the inventory system 117 is associated with the publishing system 101. The inventory system 117 includes information related to the products displayed in the content on the publishing system 101. In another embodiment, the inventory system 117 communicates with the inventory systems of the advertisers 109, to allow the advertisers 109 to track and sell products that the user 107 may select within the content. In an embodiment, content provided by the publishing system 101 to the user 107 includes one or more links to one or more products. If a user 107 activates a link by, for example and without limitation, clicking the link with a mouse, the publishing system 101 may display a checkout screen, or may add the item to a virtual shopping cart. The publishing system 101, in the embodiment, allows the user 107 to input information about the user 107, such as contact information and payment information, and transmits the contact information and/or payment information, or other information regarding the specific product indicated by the user 107, such as quantity or color preferences, to the inventory system 117. The inventory system 117 interacts with the inventory system 117 of the advertiser 109, to schedule delivery of the specific item that the user 107 selected. In another embodiment, the publishing system 101 interacts directly with the inventory system 117 of each of the advertisers 109. In another embodiment, the publishing system 101 acts as an inventory system 117, and the publishing system 101 sends, for example and without limitation, a communication such as a e-mail, a text message or one or more images in the form of a bar-code voucher or other uniquely identifiable image, a letter, a telephone call, or another form of communication, to inform the advertiser 109 that a user 107 wishes to purchase a specific item or items. Communication may be received by the user via, for example and without limitation, a mobile phone, a telephone, a smartphone, a computer, or a letter or other mailing. The communication may, in the embodiment, include information about the user 107, the method of payment, or the specific item or items that the user 107 selected. Inventory may include, but is not limited to, new products, services, or second-hand products.

The marketing system 115 is in communication with the publishing system 101, and allows a user 107 or advertiser 109 to disseminate a link or other identifier to content via one or more media feeds. For example a user 107 may click on a link, and the link may allow the user 107 to broadcast a link to the content to the user's 107 friends or acquaintances, or to post a public link to the content to allow others to review the message from the user 107 and select the link to play the content.

FIG. 2 shows a component view of the publishing system 101 according to an embodiment of the present disclosure. The publishing system 101 in the illustrative embodiment includes a processor 205 and memory containing operating system software 207, an input module 211, an output module 213, a video module 217, a preferences module 219, a checkout module 223, an advertiser portal module 225, and a marketing module. The modules may be in communication with other systems and/or databases that may operate either in the same physical computer system as the publishing system 101, or may operate on one or more separate physical computer systems. In one embodiment, the publishing system 101 is a single system. In another embodiment, the publishing system 101 is two or more systems in communication with each other. In the illustrative embodiment, the publishing system 101 includes one or more input devices 209, one or more output devices 215, one or more processors 205, and memory associated with the one or more processors 205. The memory associated with the one or more processors 205 may include, but is not limited to, memory associated with the execution of the modules, and memory associated with the storage of data. The publishing system 101 may also be associated with one or more networks 103, and may communicate with one or more additional systems via the one or more networks 103. The modules may be implemented in hardware or software, or a combination of hardware and software. The publishing system 101 may also include additional hardware and/or software to allow the publishing system 101 to access the input devices 209, the output devices 215, the processors 205, the memory, and the modules. For example, the operating system 207 software may allow modules or other systems to access the input devices 209, the output devices 215, the processors 205, the memory, and/or the other modules. The operating system 207 software may also allow one or more of the modules, or other processes in execution on the publishing system 101, to access one or more networks. In an embodiment, the modules, or a combination of the modules, are associated with a different processor 205 and/or memory, for example on distinct systems, and the systems are located separately from one another. In another embodiment, the modules are executed on the same system as one or more processes or services. In another embodiment, the same modules are executed on several systems, in a redundant and scalable load balanced architecture, to keep the performance of the system on a high level that scales to a large number of users. The modules may be operable to communicate with one another and to share information. Although the modules are described as separate and distinct from one another, the functions of two or more modules may instead be executed in the same process, or in the same system.

The memory includes computer readable media. Computer-readable media may be any available media that may be accessed by one or more processors 205 of the publishing system 101 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by the publishing system 101.

In the illustrative embodiment, the input module 211 receives information from users, advertisers 109, marketing systems 115, advertising companies 111, or other third parties or third party systems. The input module 211 may receive input over a network 103 in the form of electronic or optical signals. In an embodiment, the input module 211 receives data from the network 103, and rearranges or reprocesses the data so that it may be transmitted to other modules in the publishing system 101. Other examples of input devices 209 include, but are not limited to: computer mice, trackpads, keyboards, touch screens, cameras, and video cameras.

In the illustrative embodiment, the output module 213 transmits information received from one or more of the modules of the publishing system 101 to one or more output devices 215. In an embodiment, the output device 215 is a network 103, which may be the same network 103 used as an input device 209, or may be a different network 103. Other examples of output devices 215 include, but are not limited to: television screens, computer monitors, and printers.

In the illustrative embodiment, the video module 217 communicates with the video database 113. The video module 217 receives uploaded content from users, advertisers 109, and/or advertising companies 111, and transmits them to the video database 113 for storage. The video module 217 also receives requests to transmit content to clients 105, accesses the content in the video database 113, and transmits the content and/or additional information to the requesting client 105.

The video module 217 may allow the entity that uploaded the content to edit the content, to provide for advertisements and/or other indicators in the content. For example, the video module 217 may include tools to edit the content to include additional items for display or sale. The entity may add items not in the original video. The video module 217 may also provide tools to allow the entity to add items to the content or alter items within the content. For example, and without limitation, the sound effects, music, background music, images, background, and relevant content may be altered, added, or deleted from the content. Content originally intended to highlight or display one item or items may be modified to display other items, so, for example, if hats and shirts were displayed in content, but are currently sold out, the entity can attach dresses and shoes instead, and may change the items displayed, the prices, and the music or background. The video module 217 may also allow content to be cropped for time or content, or may allow for two or more content items to be combined into one piece of content.

In an embodiment, the video module 217 may also compress uploaded content for transmission to users and/or storage in the video database 113. The compression may be selected by the user, may be selected by an administrator of the publishing system 101, or may be a feature of the publishing system 101. In an embodiment, the video module 217 applies compression and/or re-formatting so that all types of content are the same file type and/or compression level. The video module 217 may also review the content in the video database 113, and may remove or deduplicate the content in the video database 113.

In an embodiment, coupons may be included with content that include, for example, bar codes that may be displayed with the content. The barcodes may be created from stock data about the item to which the barcode applies. The coupons allow the advertiser 109 to give an additional discount on an item that may appear in the content, or may not appear in the content. The visual display of the coupon may contain the advertiser's 109 logo, a logo for the publishing system 101, and a visual of the advertisement. In an embodiment, an inventory number of products to be sold at the discount are set at the inventory system 117 or publishing system 101, and sales decreases the inventory number until no products remain, and the discount is automatically or manually removed from the publishing system 101.

In the illustrative embodiment, the preferences module 219 is in communication with the relationship database 221. The preferences module 219 receives requests for customer information, and accesses the relationship database 221 to provide the customer information, if the customer information is located in the relationship database 221. Customer information, in an embodiment, includes information collected from users and/or clients 105, advertisers 109, and advertising companies 111. The preferences module 219 may provide the customer information to the other modules of the publishing system 101, or may provide the customer information to other, third party computer systems. The preferences module 219 may provide customer information to, for example and without limitation, an advertiser 109 or an advertising company 111. In an embodiment, the user 107, the advertiser 109, or the advertising company 111, or other third party, may request that the publishing system 101 restrict the amount or type of customer information that is provided. Each user 107, advertiser 109, or advertising company 111 with an account or an entry in the relationship database 221 may separately select one or more levels of privacy, or a level of privacy may be chosen by, for example, an administrator of the publishing system 101 for one or more groups of accounts or entries.

The relationship database 221 stores and recalls data provided by or otherwise known about the plurality of users 107, advertisers 109, and/or advertising companies 111. In an embodiment, the relationship database 221 uses a relational database to store the data. In another embodiment, the relationship database 221 uses other structures to store the data. For example, the relationship database 221 may include data stored in a hierarchical data structure, a flat file data structure, or another type of data structure that may allow the storage and recall of data. In an embodiment, the relationship database 221 operates on the same system or group of systems on which the publishing system 101 operates as, for example and without limitation, a separate electronic process or processes. In another embodiment, the relationship database 221 operates on a system that is separate from the publishing system 101, and the publishing system 101 and the relationship database 221 are in communication via, for example and without limitation, one or more networks or one or more dedicated connections. In another embodiment the same modules are executed on several systems, in a redundant and scalable load balanced architecture, to allow the systems to scale to a large number of users.

In an embodiment, the relationship database 221 stores data related to users. For example, and without limitation, the relationship database 221 stores unique identifiers associated with users such as usernames and passwords. The relationship database 221 may also store information related to a user's 107 preferences. The preference information may include preferred viewing formats, preferred viewing platforms, bookmarked content, preferred types of content, privacy settings, assent to share information with advertisers 109 or other users, or preferred methods of contact. In an embodiment, if an advertiser 109 uploads content that matches a user's preferences, or a deal is offered that matches a user's preferences, the user is contacted and information related to the content or the deal is displayed.

The relationship database 221 may also store information related to the user 107. The customer information may include, but is not limited to: name, age, additional demographic information, home address, e-mail address, social networking identifiers, telephone numbers, facsimile numbers, names or identifiers for acquaintances, or household demographic information. Some or all of the customer information may be used to populate data in fields so that the user 107 may purchase items and have them delivered more efficiently. For example, a user's 107 home address may be populated in the “address” fields of a checkout screen, if the user 107 has previously signed in with the user's 107 authentication information. In an embodiment, some or all of the information stored in the relationship database 221 may be encrypted.

In an embodiment, the relationship database 221 stores payment information associated with a user 107. The payment information may include, but is not limited to: credit card or debit card numbers, expiration dates, and security codes, or checking account or savings account numbers, or other identifying information required or useful to submit one or more payment requests to a bank or other financial institution. Information on one or more forms of payment may be stored with the user's 107 information in the relationship database 221. Some or all of the payment information may be used to populate data in fields so that the user 107 may purchase items more efficiently. For example, a user's 107 credit card number may be populated in the “credit card number” field of a checkout screen, along with expiration date and/or security code information, if the user 107 has previously signed in with the user's 107 authentication information. Payment information may also include an account number or other identifier to transmit payment to an advertiser 109 or to an advertising company 111, if a user 107 purchases an item from the publishing system 101. In the embodiment, payment may occur in any currency, and the publishing system 101 and/or checkout module 223 converts the currency paid to the currency owed. The seller of the products may request a specific currency, or the user may pay in a specific currency.

In an embodiment, the relationship database 221 stores history information. The history information may include, but is not limited to: social media interaction that the user 107 has taken through the publishing system 101, the time, date, and/or the number of times a user 107 has accessed a particular content item, the length of time a user 107 spent with a particular content item, information regarding completed or uncompleted purchases that the user 107 made while viewing the content item, the time, date, and unique identifier for coupons or other items that the user 107 accessed, the number of times, time, and date that a user 107 accessed other areas of additional content of the publishing system 101, and the actions the user 107 took with respect to the additional content. The history information may also include an identifier of the hardware and/or software of the client 105, and additional information provided by the network 103.

In an embodiment, the relationship database 221 stores advertiser information. The advertiser information may include, but is not limited to: a unique identifier for the advertiser 109, such as a username and password combination, account information, the content that is linked or uploaded, and information related to the inventory system 117 of advertisers 109.

In an embodiment, the relationship database 221 stores advertising company 111 information. The advertising company 111 information may include, but is not limited to: a unique identifier for the advertising company 111 and affiliation information for advertising companies 111 and advertisers 109, so that an advertising company 111 may also have access to functions associated with the advertiser 109.

In the illustrative embodiment, the checkout module 223 interfaces with the inventory system 117. If the user 107 selects a link in content indicating the desire to purchase an item, the checkout module 223 may receive the signal or signals from the client 105. In an embodiment, the checkout module 223 identifies the user 107 that selected the link based on the user's 107 profile or unique identifier in the relationship database 221. In the embodiment, the checkout module 223 adds a unique code for the item in the user's 107 shopping cart, which may be maintained by the checkout module 223 and/or in the relationship database 221. The user 107 may select an option to check out, and the checkout module 223 may transmit checkout information to the client 105. The user may continue to checkout immediately, pausing or stopping the content from playing, or the content may continue playing, and the checkout information may be transmitted to the client 105 after the content is complete, or until the user quits the content or navigates to a checkout area or screen. In an embodiment, if the user has previously supplied billing and shipping information, the user may checkout module 223 may apply the information to complete the checkout procedure. The user, in the embodiment, may not be required to input any additional information, or a small amount of information, such as a username and/or password. The checkout information may include, but is not limited to, information related to the item or items that the user 107 selected, the user's 107 contact information, the user's 107 payment information, or additional information to describe the transaction and/or the item for purchase. In an embodiment, the checkout information is stored in the relationship database 221 and is associated with the user's 107 unique identifier.

In the illustrative embodiment, the advertiser portal module 225 provides an interface for the advertiser 109 and/or the advertising company 111 to the publishing system 101. The advertiser 109 and/or the advertising company 111 may upload content to the publishing system 101, or may view statistics on content associated with the advertiser 109. In an embodiment, the advertiser 109 and/or advertising company 111 also transmits preference information and other information regarding inventory, billing, or contact information to the advertiser portal module 225, which then transmits the information to the preferences module 219 and the relationship database 221. The advertiser portal module 225 may provide statistical information to the advertiser 109 and/or the advertising company 111 related to the content that the advertiser 109 and/or advertising company 111 has uploaded or made available to the publishing system 101. The advertiser portal module 225 may also allow the advertiser 109 to communicate with users who have selected to receive information from the particular advertiser 109 or from groups to which the advertiser 109 is associated. The communication may include that a new piece of content has been uploaded or is available, or the advertiser 109 may communicate deals and/or other non-content items to users. The advertiser 109 portal may allow messages to be transmitted to specific sub-groups of users. For example, users who have viewed content by the advertiser 109, or users who have viewed content by the advertiser 109 and completed a purchase of one or more items from the advertiser 109. Advertisers 109 may also have a virtual “store” that allows users to view items sold by the advertiser 109 and/or content uploaded by the advertiser 109.

In the illustrative embodiment, the marketing module transmits and receives information from one or more marketing systems 115. For example, and without limitation, marketing systems 115 may include FACEBOOK®, TWITTER®, or other social networking systems, or file sharing sites such as YOUTUBE®. A user 107, advertiser 109, and/or advertising company 111 may utilize one or more of the marketing networks to inform additional users about the availability of content, or may use one or more of the marketing networks to send additional information related to the content, such as a user's 107 purchase of a product, or endorsement of a product or content, as in the case of a user 107 “liking” or “disliking” a particular item of content. The marketing systems 115 may be associated with the publishing system 101, or may be provided by third parties. A module is created or modified to send signals from the publishing system 101 to the marketing system 115 in a format that the marketing system 115 can receive and interpret. The users may be able to share the purchasing and content viewing experience with others via the social networking tie-ins, and users may upload video or other content of themselves purchasing products and viewing content. The publishing system 101 may provide incentives for a user 107 to do so, by, for example and without limitation, offering a sweepstakes for users who upload content. Users may organize with friends or others on social media outlets into groups, and the groups may recognize additional deals or gifts. Additionally, users may respond and comment on other users' comments or content.

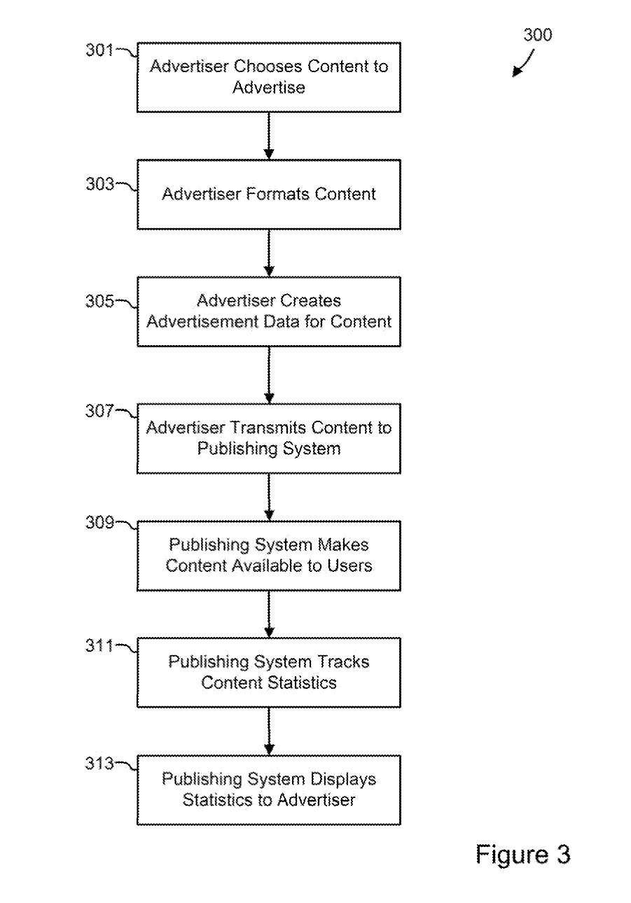

A method of making content available according to an embodiment of the present disclosure is shown in FIG. 3. While an advertiser 109 is shown creating content and uploading the content to the publishing system 101 in FIG. 3, other entities may create content, and the content need not be hosted within the publishing system 101. In box 301, the advertiser 109 chooses content in which to advertise one or more products. The content may include, but is not limited to, video, audio, static images, or text, or may include a combination of two or more of forms of content.

In box 301, the advertiser 109, user 107, or advertising company 111 chooses content to use for an advertisement. The content may be an existing video or other content stored with the publishing system 101, or may be a new content created by the advertiser 109, the user 107, or the advertising company 111. In an embodiment, the user 107 creates the content. In another embodiment, the content is created by one or more small businesses, and displays the small business's products or services. In another embodiment, the content is created by one or more advertising companies 111 or advertising agencies, on behalf of one or more clients, which may be businesses or individuals. In another embodiment, the content is created using an editing system, or hardware operating software to accomplish a task of creating or editing content, associated with the publishing system 101, and the user of the editing system uploads content or creates content with the editing system that is combined and transmitted to the publishing system 101. In another embodiment, the content is created by the administrators or others associated with the publishing system 101. In another embodiment, portions or full pieces of content, such as movies, that are royalty free, either by expiration of copyright or other agreement, are provided by the publishing system 101 for use, or are uploaded to the publishing system by others. In another embodiment, portions or full pieces of content are provided by others, such as movie studios or other rights holders, under an agreement to, for example, share profits or pay a royalty fee. In another embodiment, portions or full pieces of content are provided by the publishing system 101 by a stock royalty agreement, or are provided by a third party by a stock royalty agreement. In another embodiment, the content includes a testimonial or other description of one or more products by a celebrity or other influential person. In an embodiment, the user 107 may create a video and audio, and may choose to advertise an advertiser's 109 products or services using the video and audio. In another embodiment, the advertiser 109 creates video and audio for one or more of their products, and chooses to advertise the products using the video and audio. In another embodiment, the publishing system 101 maintains one or more pieces of content, and the users and/or the advertisers 109 may access the content and create their own advertisements from the pre-existing content.

In box 303, the advertiser 109, user 107, or advertising company 111 formats the content. If, for example, the content is in the form of a series of images, the series of images may be formed into a video or a slideshow of the images. If the content is video, the video may, for example, be cropped, edited for content, resized, made into a resolution higher or lower than the resolution of the original video, make the video clickable by adding hotspots, segments, and traced segments, or the volume may be changed. Additionally, tools may be available to stabilize a video to appear smoother, remove unwanted background sounds and/or images. The publishing system 101 may provide tools to format the content. For example, and without limitation, the content may be uploaded to the publishing system 101, and tools associated with the video module 217 may be used by the advertisers 109, user 107, or advertising company 111 to alter the content. In an embodiment, tools may be provided by the publishing system 101 to format the content. The tools may be, for example, downloaded from a website of the publishing system 101 to a computer with the content or with access to the content, and the tools may be used to format the content.

In box 305, the advertiser 109, user 107, or advertising company 111 may create advertisement data associated with the content. For example, and without limitation, one or more items of an advertiser 109 may be associated with the content. In one embodiment, if the content is video, a box or other indicator may be placed within the video to indicate an advertisement or the ability to purchase an item that is currently shown in the video. A user 107 may be able to select one or more of the boxes, and the selection is transmitted to the publishing system 101. The publishing system 101 receives the selection information provided by the client 105 and retrieves information related to the product or service identified in the selection, and may add the item to a checkout cart or may suspend the video to allow the user 107 to complete purchase information in an embedded checkout screen or a checkout screen that is different than the screen with the video. Additional items may also be added to the video that may not be present in the video. The advertisement data may be separate from the content, or the advertisement data and the content may be stored together, including as a single electronic file. Advertisement data may also include, but is not limited to, category, product or products offered, geographical area, stock data, price before and after the discount, any other existing benefits for group buyers, and end date and/or time of the offer or removal date of the content. The publishing system 101 may use the advertisement data to enable users to search for content based on the values provided in the advertisement data.

In an embodiment, the advertiser 109, user 107, or advertising company link the item to be offered for sale in the content to the item, so that the publishing system 101 may know which item to transmit to the inventory system 117. Items may be uniquely identified by the advertiser 109 or other entity so that the publishing system 101 is able to track which item a user 107 selects, if a user 107 views the content with the item. In an embodiment, the advertiser 109, user 107, or advertising company provide the content to the publishing system, and an image recognition system, administrator, or operator views the content and links the appropriate items in the publishing system 101. In another embodiment, a user 107 or group of users may request a deal on an item, and the publishing system 101 may transmit the request to the advertiser 109. The advertiser 109 may choose to fulfill the request.

In box 307, the advertiser 109, user 107, or advertising company 111 transmits the content and the advertisement data to the publishing system 101. In one embodiment, the content and advertisement data are uploaded to the publishing system 101. In another embodiment, the advertisement data is uploaded to the publishing system 101, and a link or other identifier for the content is also transmitted to the publishing system 101. The publishing system 101, in the embodiment, provides the link or other identifier for the content to the client 105 if the client 105 requests the content, and the client 105 requests the content from a third party system or another system associated with the advertiser 109, the user 107, or the advertising company 111. Transmitting a link or other identifier allows the content to be stored on a computer system other than the publishing system 101. In another embodiment, the advertiser 109, the user 107, or the advertising company 111 transmit a link or other identifier to the publishing system 101 for both the content and the advertisement data.

In box 309, the advertiser 109, user 107, or advertising company 111 allows the publishing system 101 to make the content available to users. The content may be stored with the publishing system 101, but may not be available to users for a period of time. For example, the advertiser 109, user 107, or advertising company 111 may create additional content, and may wish for all of the content to be available at the same time. The publishing system 101 may store the content and the advertisement data, but may not make the content or advertisement data available to users until specified by the advertiser 109, the user 107, or the advertisement company.

In box 311, after the content is made available to users, the publishing system 101 may track information related to the content. The information may include, but is not limited to: the number of views, demographic information of viewers, the number and identity of users who have provided links to the content via one or more social networking or other marketing sites, the number and identity of users who have selected links to products in the content, the number and identity of users who have completed purchases after selecting links to products in the content, or other information provided by users when interacting with the content. The information may be created on an individual user basis, or the information may be aggregated to present statistical information to the user 107, the advertiser 109, or the advertising company 111.

In box 313, the publishing system 101 provides access to the information from box 311 to the advertiser 109, the user 107, or the advertising company 111. The information may be presented by the publishing system 101 for review and analysis, or the information may be transmitted to the user 107, the advertiser 109, or the advertising company 111 for review and analysis outside of the publishing system 101.

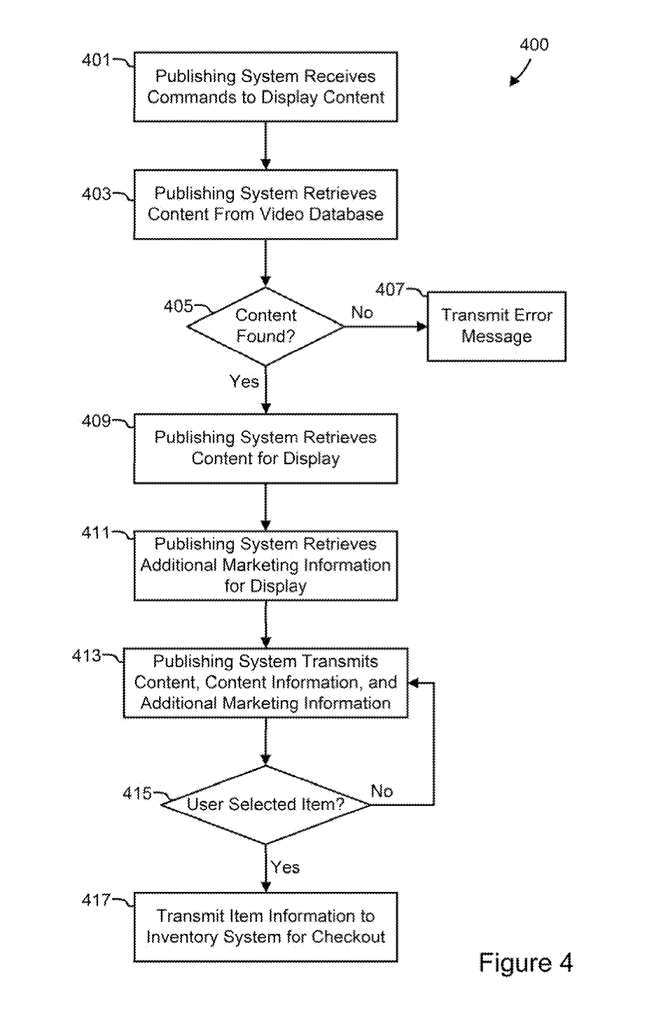

A method of receiving a selection for content and displaying content and advertisement according to an embodiment of the present disclosure is shown in FIG. 4.

In box 401, the user 107, through the client 105, requests content from the publishing system 101. The user 107 may navigate to a web site associated with the publishing system 101 and may, for example, click a link to an item of content, or may transmit a search command to the publishing system 101 through a web site associated with the publishing system 101. The search command may allow the user 107 to segment content by, for example, category, product, geographical area, price before and after a discount, any other existing benefits for group buyers, and end date of the offer. The publishing system 101 may query the video database 113 and transmit one or more search result web pages with search results to the client 105. In an embodiment, a guided tour is available for a user 107 and/or an advertiser 109, to acquaint the user 107 and/or advertiser 109 with the process and the aspects of searching for and viewing content.

In box 403, the publishing system 101 attempts to retrieve the requested content from the video database 113. The advertising module of the publishing system 101 may retrieve the content, the advertising information, or both. In box 405, if the content is not located within the video database 113 or third party system, the advertising module and advertising system 101 transmits an error message to the client 105, shown in box 407. If the content is located within the video database 113 or one or more third party systems, the advertising module and advertising system 101 retrieves the content from the video database 113, shown in box 409.

In box 411, the publishing system 101 and the video module 217 retrieves the advertising information associated with the content. In an embodiment, the content and the advertising information are in a single file. In another embodiment, the content and the advertising information are in two or more electronic files. The video database 113 or the video module 217 may associate the content file or files with the advertising information file or files, so that if an item of content is selected, the associated advertising information files are also identified and retrieved.

In box 413, the publishing system 101 transmits the content and the advertising information to the client 105. In an embodiment, the publishing system 101 transmits the content to the client 105, and transmits a link or other identifier for the advertising information to the client 105, and the client 105 may request to retrieve the advertising information from a third party system. In another embodiment, the publishing system 101 transmits the advertising information to the client 105, and transmits a link or other identifier for the content to the client 105.

In box 415, the publishing system 101 may monitor the content as it is streamed to the client 105, and may wait for the user 107 to select an item within the content. The user 107 may select one or more items within the content. For example, the user 107 may use a mouse or other input device 209 to click on an item appearing in the content. For example, the user 107 may click on an item of clothing that an actor in the content is wearing or interacting with. In another embodiment, one or more items may be present in the content inside, or outside of the video as in, for example, a separate window or a portion of a window or other device to display the content. If the user 107 selects an item or items from the content, the client 105 transmits information to the publishing system 101 related to the item or items. For example, the client 105 may transmit the time elapsed from the beginning of the content and the coordinates of a user's 107 click or other interaction with the content. The client 105 may also transmit a unique identifier for the content. In another embodiment, the client 105 may transmit a unique identifier for the item or items that the user 107 selected. If no item is selected, or if the user 107 clicks or otherwise indicates on a portion of the content that is not active or linked to an item or items, the method may return to box 413, and may continue to transmit the content to the client 105. In an embodiment, content is related to one advertiser 109. In another embodiment, more than one advertiser 109 may have products represented in a single piece of content. For example, a movie clip may contain products from two or more different advertisers 109. Two or more products may be selectable by the user 107. In another embodiment, a single product in a piece of content may be sold by more than one advertiser 109. If a user 107 selects a product that is sold by more than one advertiser 109, the user may be able to select an advertiser 109 to purchase the product. The user 107 may be able to order the information from the selection by, for example and without limitation, sale price, merchant reviews, shipping price, or a combination of two or more selection criteria.

In box 417, the publishing system 101 receives the information from the client 105, and matches the information to an item or receives the item unique identifier from the client 105. The publishing system 101 transmits the information to the inventory system 117 for checkout, and the user 107 may be redirected to one or more websites of the inventory system 117 or a separate window or other interface may be presented on the client 105 to allow the user 107 to complete a checkout process. During checkout, the user 107 may additionally receive a questionnaire to indicate feedback with the system, with the content provided and/or reviewed, and/or a community contribution questionnaire to indicate if the user 107 would like to donate to one or more destinations. Additionally, in an embodiment, a percentage of profits may also be distributed to destinations, and the user 107 may receive a questionnaire to vote on or direct distributions.

In an embodiment, the publishing system 101 transmits a voucher or other token that may be accessed by the user 107. For example, the voucher may be a code, or a barcode, or a picture, or other unique identifier that a user 107 may print and may take to a store. The voucher may be scanned at the store, or may be presented at the store, in exchange for the item that the user 107 purchased. In an embodiment, the voucher may serve to identify a product, which may be purchased at the store. In another embodiment, the voucher serves to identify a product and payment, so that the user 107 does not present further payment. In an embodiment, the voucher is not printed, but is transmitted to a user's 107 portable device, such as a laptop, netbook, tablet computer, smart phone, or other phone, where it may be scanned or presented at a store in exchange for an item or items.

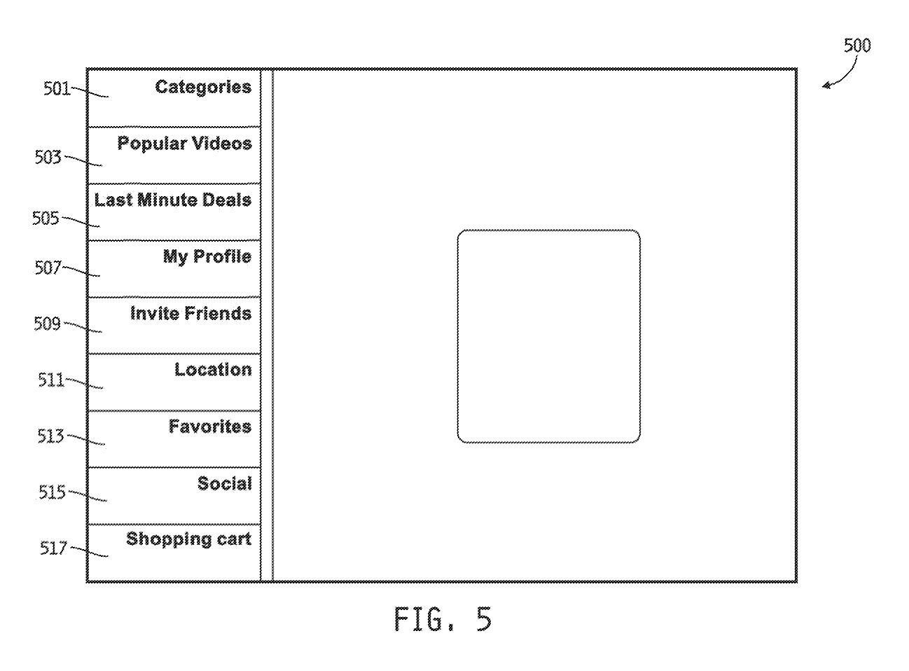

FIGS. 5-22 are described with respect to an exemplary embodiment of the present disclosure. FIGS. 5-22 show exemplary screen images that may be displayed on a client 105, and that depict features described in the present disclosure. The figures are exemplary, and other embodiments may show features in a different manner, may show additional features, or may not show one or more features. The present disclosure is not intended to be limiting to the specific layout or feature set shown in FIGS. 5-22.

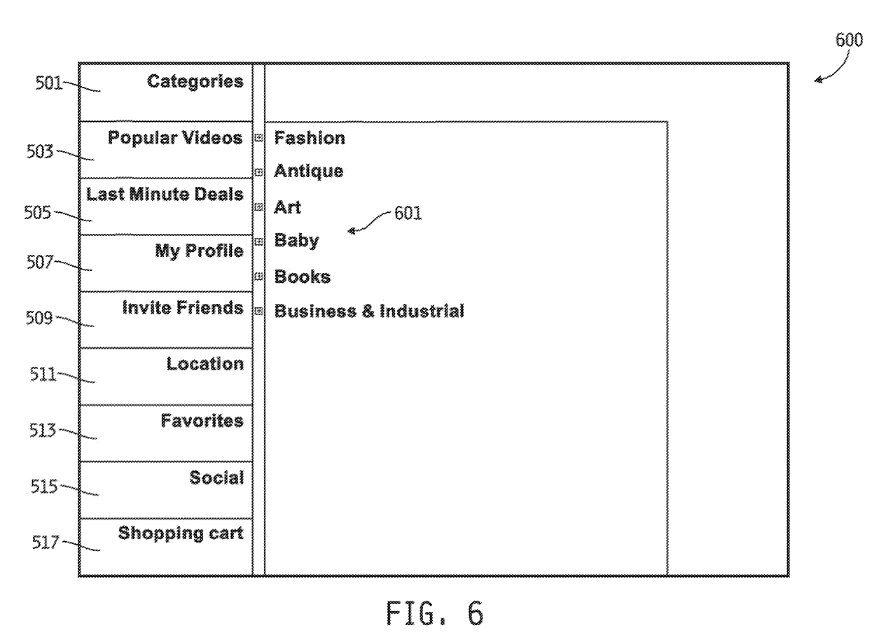

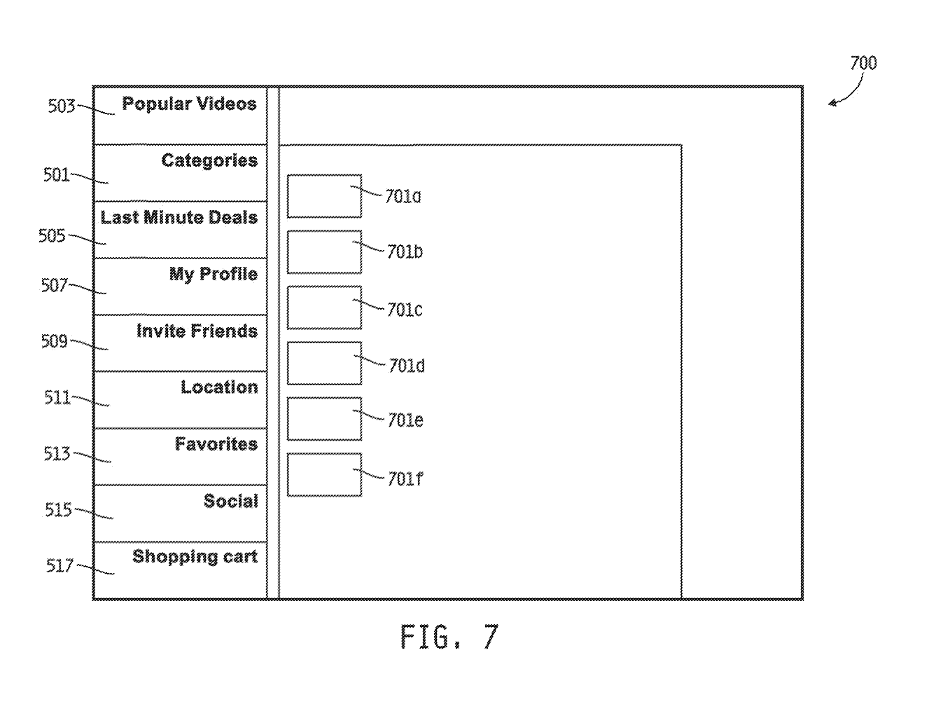

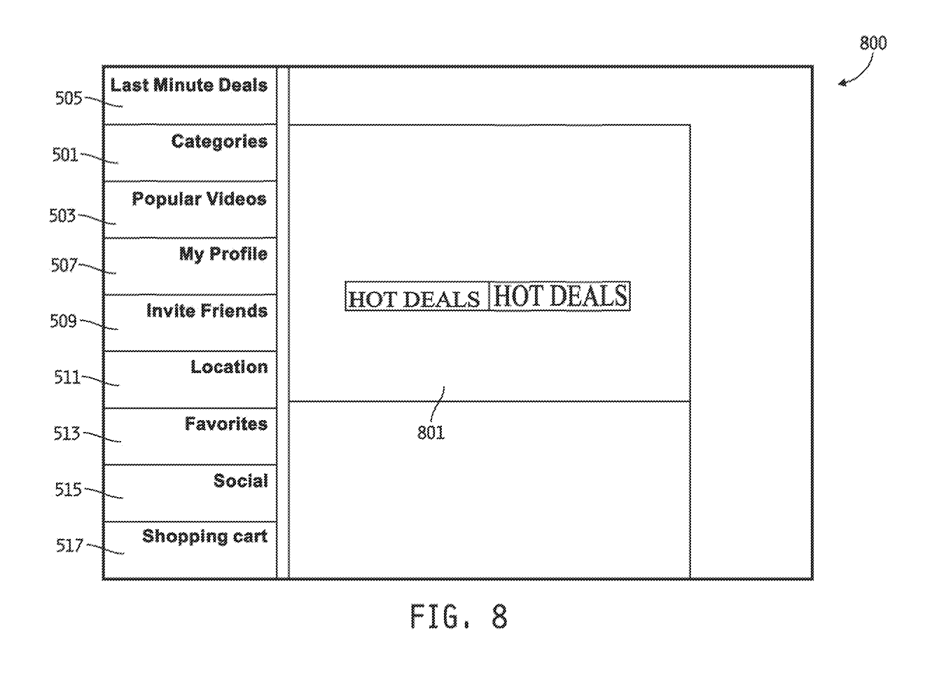

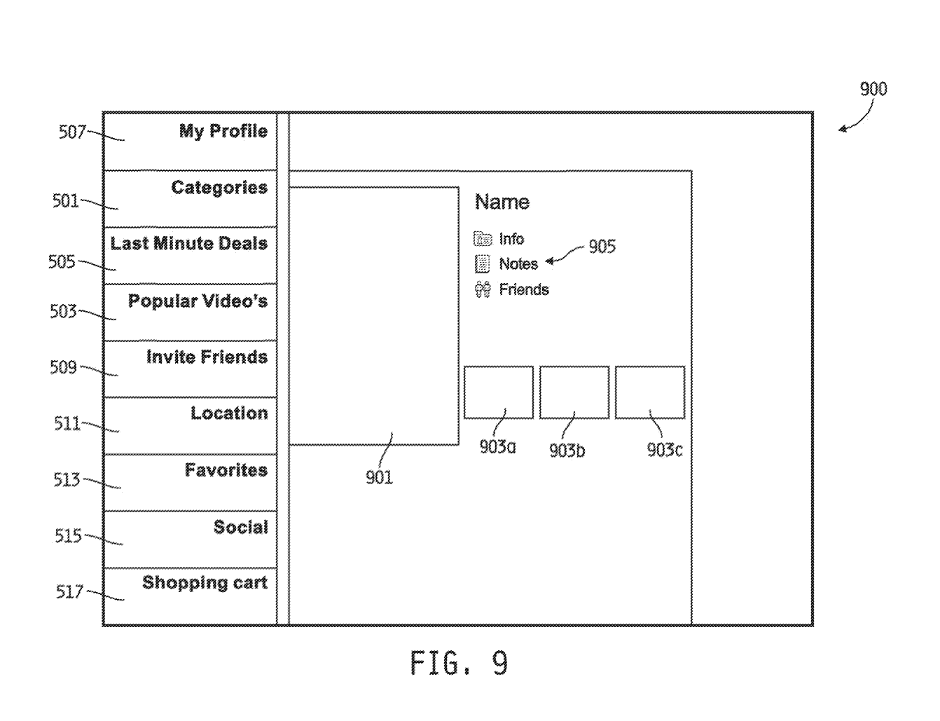

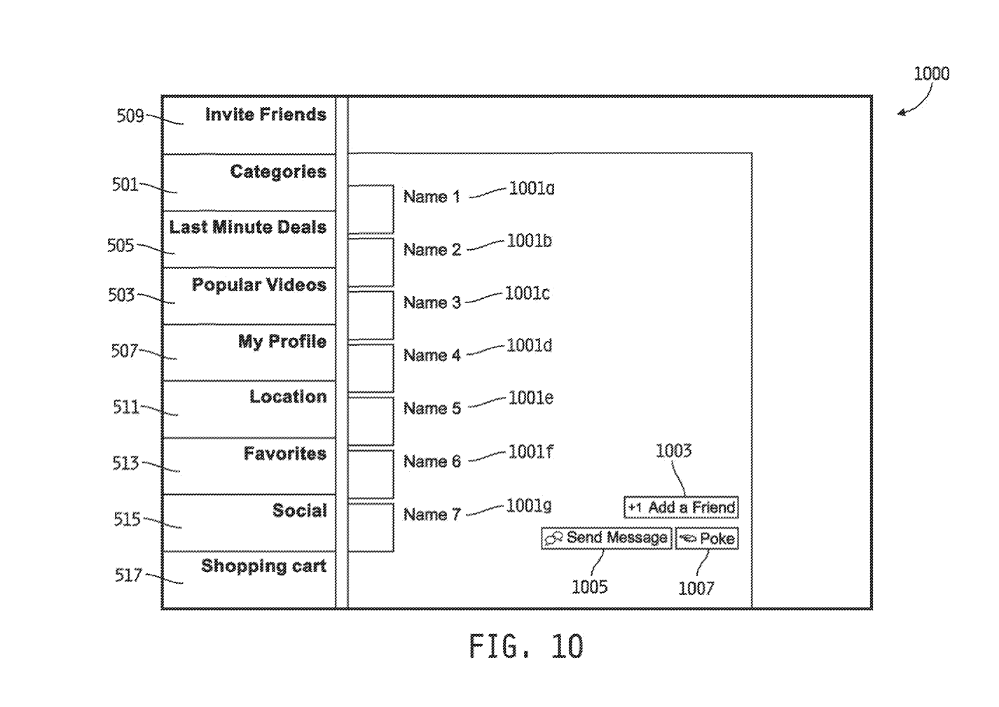

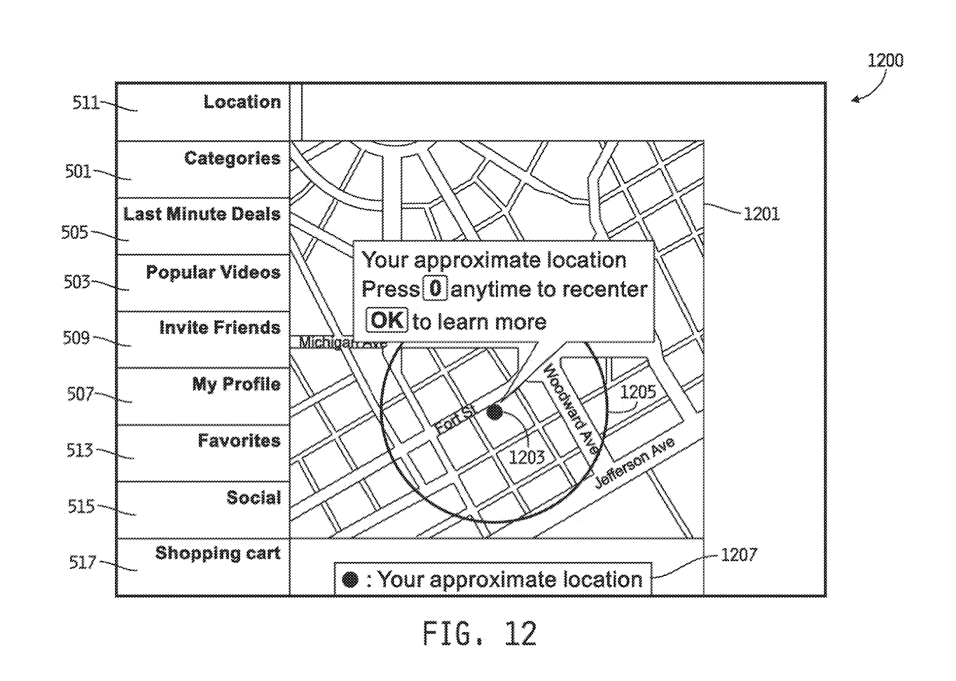

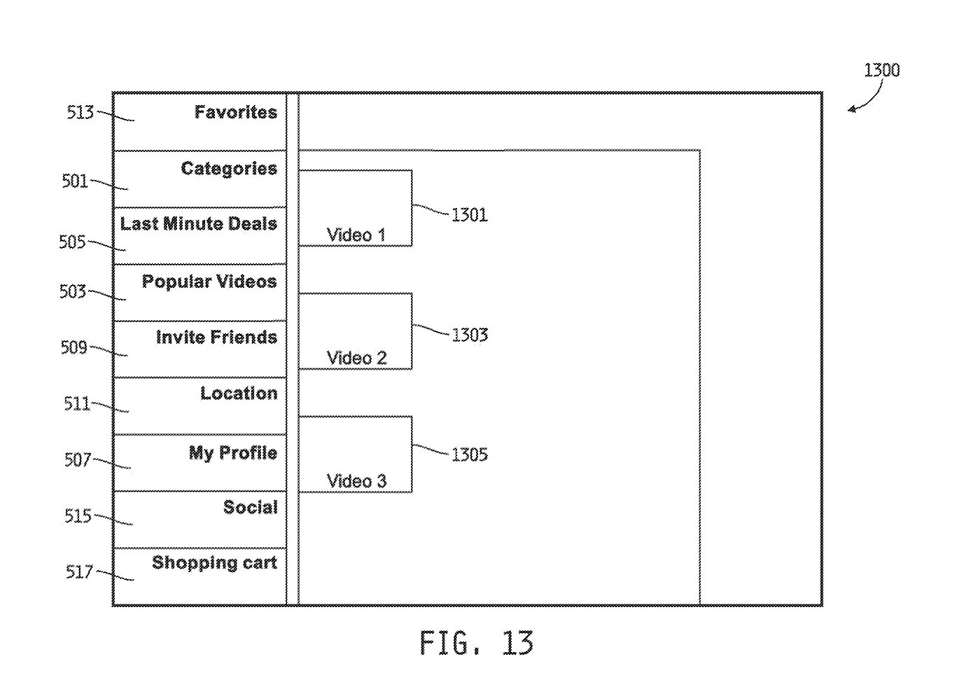

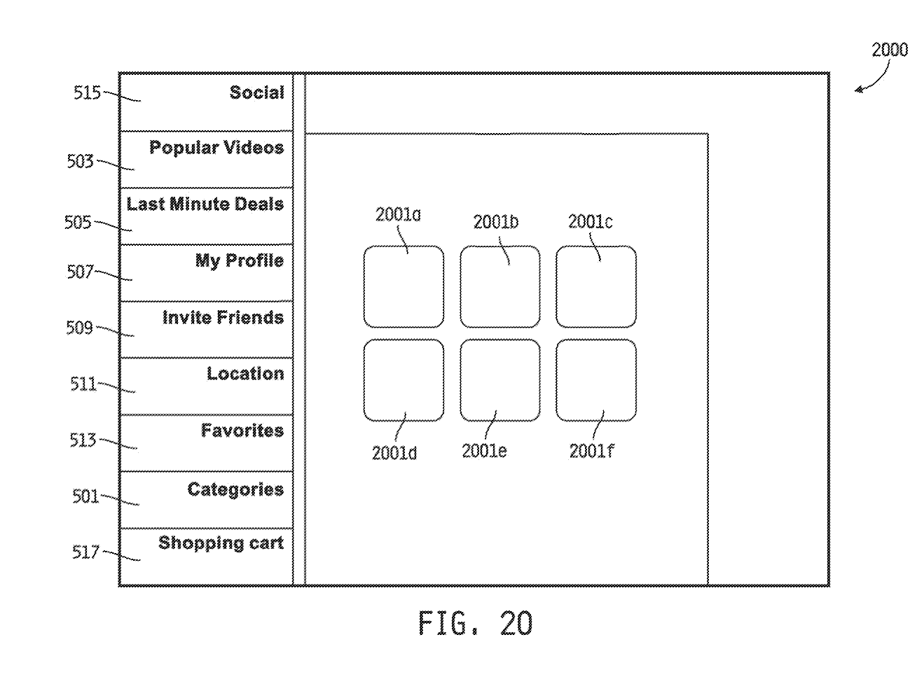

FIG. 5 shows an exemplary start screen 500 according to an embodiment of the current disclosure. A navigation bar provides a list of options for a user 107 to choose, and screens activated by the buttons are described more fully below. For example, an exemplary screen for the “Categories” selection 501 is shown in FIG. 6. An exemplary screen for the “Popular Videos” selection 503 is shown in FIG. 7. An exemplary screen for the “Last Minute Deals” selection 505 is shown in FIG. 8. An exemplary screen for the “My Profile” selection 507 is shown in FIG. 9. An exemplary screen for the “Invite Friends” selection 509 is shown in FIG. 10. An exemplary screen for the “Location” selection 511 is shown in FIG. 12. An exemplary screen for the “Favorites” selection 513 is shown in FIG. 13. An exemplary screen for the “Social” selection is shown in FIG. 20. An exemplary screen for the “Shopping Cart” selection 517 is shown in FIG. 21.

FIG. 6 shows a screen 600 with an exemplary set of categories according to an embodiment of the present disclosure. In an embodiment, the categories 601 are chosen by an administrator or operator of the publishing system 101. In another embodiment, the categories 601 are generated by the publishing system 101, based in part on the content or data associated with the content. For example, an advertiser 109 may select one or more words to describe the content, and may transmit the metadata along with the content to the publishing system 101. The publishing system 101 may use the metadata to describe the content, and may create one or more categories based on the metadata of the content.

FIG. 7 shows a screen 700 with an exemplary set of popular videos according to an embodiment of the present disclosure. The popular videos 701a-701f are arranged in the screen according to one or more criteria. For example, the popular videos 701a-701f may be arranged according to total views by users, or may be arranged by popularity or rating. Popularity or rating may be defined by ratings provided by users. The popular videos 701a-701f may be selected by users, or may be selected by an administrator or operator of the publishing system 101. In one embodiment, the sorting criteria for popular videos may be set by the user 107. For example, the user 107 may choose to sort content by the number of views, or the number of views within a specified time period, or the popularity of the content. The publishing system 101 may reorder the content according to the user's 107 preferences. In an embodiment, the user's 107 preferences for sorting and displaying videos may be set in the user's 107 preferences, so that a user 107 may authenticate to the publishing system 101, and the publishing system 101 may display content according to the user's 107 preferences.

FIG. 8 shows an exemplary screen 800 of last minute deals according to an embodiment of the present disclosure. An advertiser 109 or an advertisement company may transmit coupons or other deals to the publishing system 101. The publishing system 101 may display the coupons or other deals on the site, so that a user 107 may review the coupons or other deals. The user 107 may select one or more of the coupons or other deals, and may enter the checkout system to take advantage of the coupons or other deals, or the publishing system 101 may redirect the user 107 to the advertiser's 109 own website or other site to complete a purchase.

FIG. 9 shows a screen 900 with an exemplary user 107 profile according to an embodiment of the present disclosure. The profile may include an image 901 or avatar for the user 107. Other users may be able to see the avatar next to, for example and without limitation, comments provided by the user 107 on an item of content. The user 107 may be able to create lists of friends that also have profiles with the publishing system 101. The publishing system 101, in an embodiment, provides tools 905 to create, maintain, and delete friendships with other users. The tools 905 may allow a user 107 to change the user's 107 profile information, change privacy settings to display or hide information on the profile with other users, and request, accept, or deny friendships with other users. A friendship connection may provide the user 107 with additional information on the users that the user 107 creates a friendship with. Additionally, in an embodiment, content 903a-903c may be displayed. The content 903a-903c may be, in one embodiment, a list of the recent content that the user 107 viewed, or a list of the content that the user 107 has viewed most often, or a list of content that the user 107 has rated the highest. The content 903a-903c may include one or more links, so that the user 107 may select the content and thereby access the content.

FIG. 10 shows an exemplary screen 1000 allowing a user 107 to invite friends according to an embodiment of the present disclosure. The friends screen may display a list of the user's 107 friends, shown as 1001a-1001g. In an embodiment, the friends screen may also display potential friends, or friends that have not yet accepted a user's 107 requests to create a friendship. In an embodiment, additional tools may allow a user 107 to add or remove friends, as in button 1003, or send messages to friends, shown in button 1005 and 1007. The user 107 may communicate (telephone calls, text messages, chat, e-mail, video-chat or -mail, or other forms of communication) privately with one or more friends, or may communicate (telephone calls, text messages, chat, e-mail, video-chat or -mail, or other forms of communication) publicly with one or more friends.

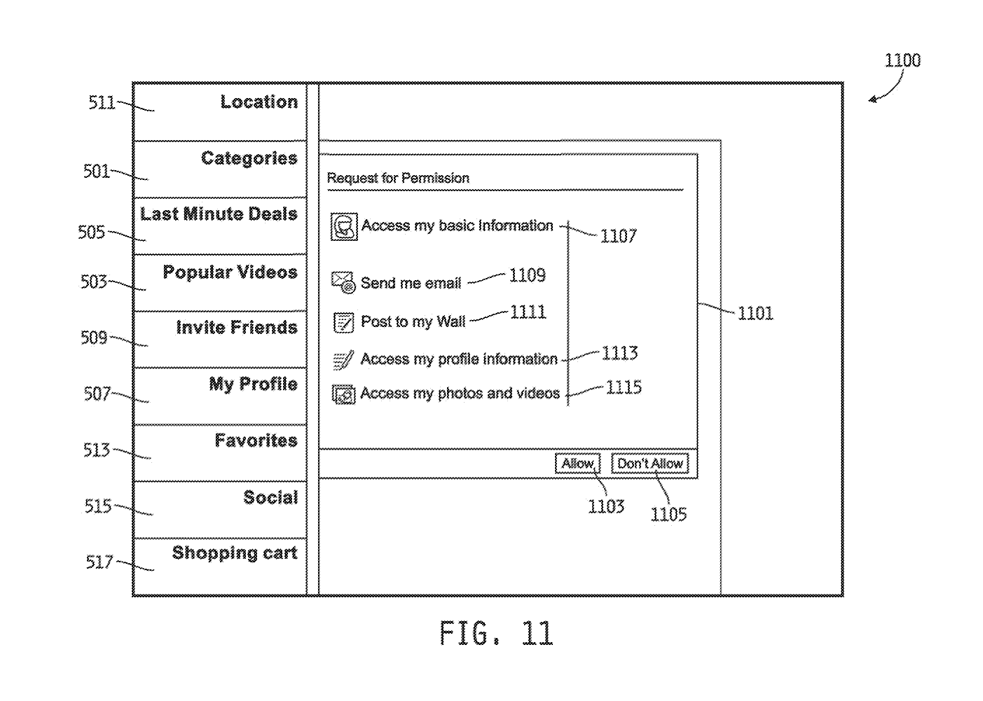

FIG. 11 shows a screen 1100 requesting a user 107 give permission for a site to access the user's 107 information according to an embodiment of the present disclosure. Notification features 1101 of the publishing system 101 may be selectively enabled or disabled, depending on the user's 107 preference. For example, a basic information screen 1107 may allow a user 107 to set or reset a username or password, or create other identifying information for the publishing system 101. A notification screen 1109 may allow a user 107 to receive e-mail, telephone calls, video chats, or other forms of communication from other users, from a user's 107 friends, or from advertisers 109 or the publishing system 101. A personal contact screen 1111 may allow a user 107 to allow other users, a user's 107 friends, or advertisers 109 to post content to the user's 107 publicly or privately available area. An information access screen 1113 may be accessed to selectively share information such as address, telephone number, or e-mail address, with other users, a user's 107 friends, or advertisers 109. Each piece of information may be selected to be shared separately, or all of the information may be shared or not shared with certain groups. A content access screen 1115 may allow a user 107 to provide access to content that the user 107 provided or uploaded to other users, the user's 107 friends, or advertisers 109. Enablement 1103 and disablement 1105 buttons may allow a user 107 to provide access or restrict access to some or all of the notification and/or content display options provided in the publishing system 101.

FIG. 12 shows a screen 1200 with an exemplary user's 107 location on a map according to an embodiment of the present disclosure. The client 105 may use the location identifier 119 to calculate or receive the client's 105 location, which may be displayed on a location map 1201. The user's 107 approximate or exact location may be displayed on the location map 1201 as an indicator 1203. The indicator 1203 may also include a confidence interval 1205 displayed with the location map 1201. The confidence interval 1205 may allow the user 107 to determine the user's 107 approximate location. Indicator 1207 may indicate the user's 107 location, or may indicate a distance to an advertiser 109. In an embodiment, advertisers 109 who are within a predetermined range may also display on the location map 1201. The predetermined range may be set by the user 107, in the user 107 preferences, or may be set by the publishing system 101. In one embodiment, only the advertisers 109 for which the user 107 has viewed content are displayed with the user's 107 location. In an embodiment, advertisers 109 with certain categories of products are displayed with the user's 107 location, and the categories of products may be set by the user 107, or may be determined by the types of content that that the user 107 has viewed, or may be determined by the publishing system 101.

FIG. 13 shows a screen 1300 with an exemplary list of favorite videos, showing three different video display options according to an embodiment of the present disclosure. Three video display options are shown, but more or fewer video display options may be offered. In an embodiment, the user may choose the number of video display options as a preference. Favorite videos 1301, 1303, and 1305 may be selected by the user 107. For example, and without limitation, favorites may be populated by the content that the user 107 frequents most often, or may be populated with content that the user 107 has specifically selected to be a favorite. In an embodiment, the content is selected by other users. For example, favorites may be selected by the number of users that have viewed the content, or by the number of users who have purchased items featured in the content. The screen 1300 may include links to each of the content provided on the screen so that, for example, the user 107 may select the content, and may be taken to a screen to display the content.

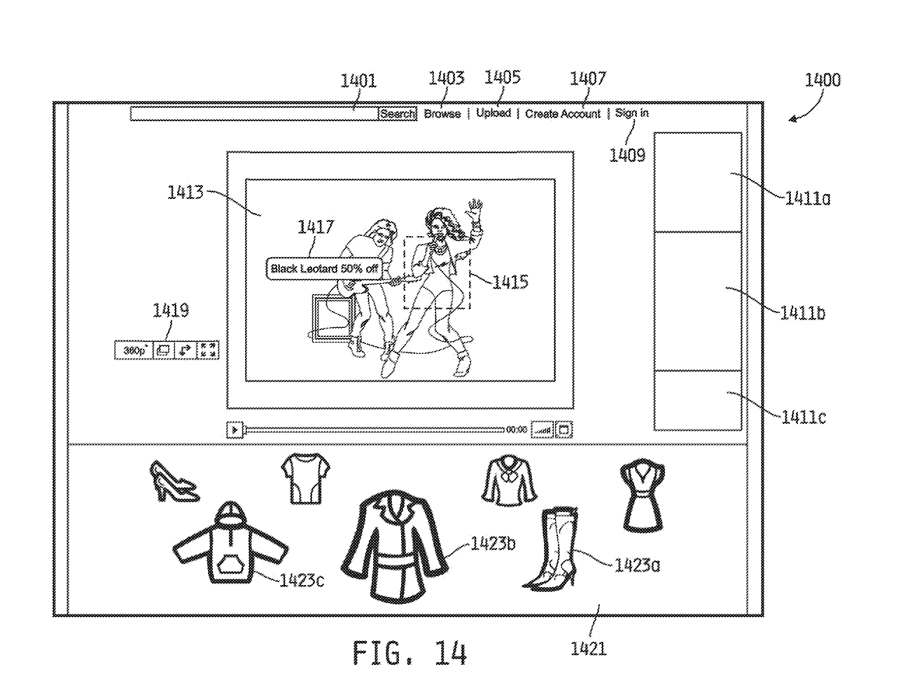

FIG. 14 shows a screen 1400 with an exemplary video 1413 with an advertisement 1417 overlaid on the video according to an embodiment of the present disclosure. In an embodiment, a video is one form of content that the publishing system 101 is capable of displaying. A box 1415 is shown over the video 1413 that follows the item as displayed in the video, and if a user 107 selects the box 1415, a pop-up advertisement 1417 is displayed. The box 1415 may also be known as an activation zone. For example, the box or selection zone 1415 follows in this case the shirt of the woman as the woman moves within the screen in the video. Selection may occur if the user 107 clicks within the box 1415 with a mouse, wherever it resides on the screen, or if the user 107 moves a cursor within the box 1415, or if the user 107 touches a finger or stylus within the box 1415. The pop-up advertisement 1417 displays information relevant to the product within the box 1415. In an embodiment, the user 107 may make a second selection either within the box 1415 or within the pop-up advertisement 1417, and the item displayed in the box or specified in the pop-up advertisement may be added to the user's 107 virtual shopping cart, or the user 107 may be redirected to one or more checkout screens to complete a purchase of the item displayed in the box 1415. The selection may also occur if the user 107 clicks on the pop-up advertisement 1417 with a mouse, if the user 107 touches the pop-up advertisement 1417 with a finger or stylus, or if the user 107 makes a second selection within the box 1415.

In the embodiment, below the content of the exemplary content, an array 1421 of items 1423a-1423c may be displayed. In another embodiment, the position of the array 1421 may be elsewhere, or the position of the array 1421 may be selectable by the user as a preference, or the user may, for example, click and drag the array 1421 to another area of the screen. The array 1421 may contain items that are featured in the content. In an embodiment, the array 1421 may contain products that the advertiser 109 indicates are related to the products featured in the content, or may contain products that other users purchased when viewing the content.

One or more coupons 1411a-1411c may also be displayed along with the content. In an embodiment, the coupons 1411a-1411c may include additional deals or savings related to the items available in the displayed content. In an embodiment, the coupons 1411a-1411c include deals or savings that are from the advertiser 109 of the content, or may include deals or savings from one or more additional advertisers 109.

In an embodiment, tools 1419 are provided to allow the user 107 to alter the content. For example, with respect to video content shown as element 1413, the tools 1419 may allow the user 107 to make the video full-screen, or otherwise change the height and width of the video. The tools 1419 may also allow the user 107 to change the resolution of the video to accommodate, for example, a faster or slower transfer speed from the publishing system 101 to the client 105.

In an embodiment, account management tools 1401, 1403, 1405, 1407, and 1409 allow the user 107 to access the user's 107 account, shown in the “sign in” link 1409, create content, shown in the “upload” link 1405, browse content available to the publishing system 101, shown in the “browse” link 1403, upload or create new content, shown in the “upload” link 1405, or search for content available to the publishing system 101, shown in the “search” link 1401.

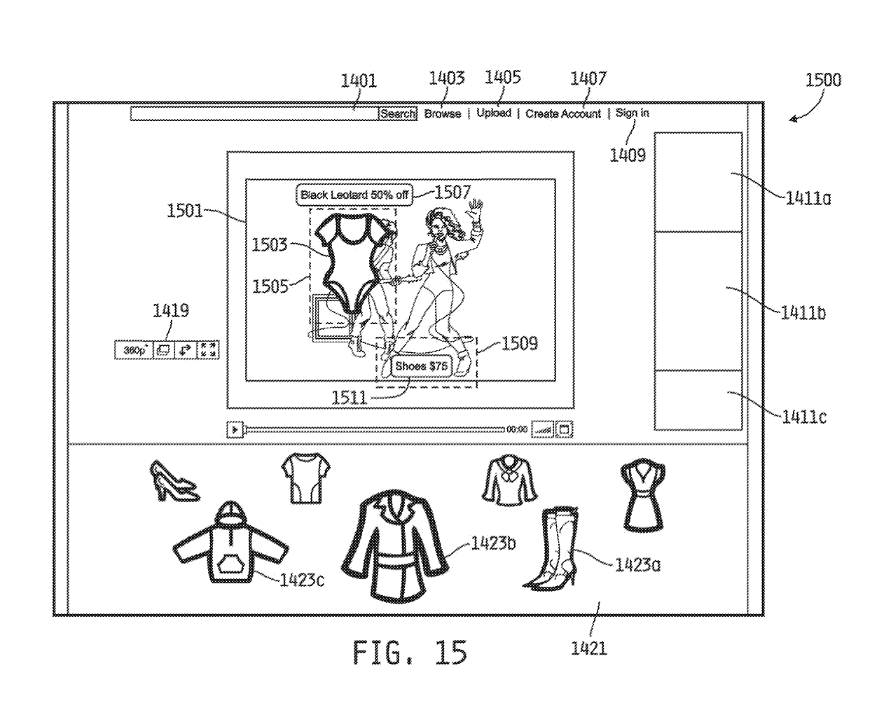

FIG. 15 shows a screen 1500 with an exemplary video 1501 with an advertisement 1503 overlaid on the video 1501 according to an embodiment of the present disclosure. The box 1509 and the pop-up advertisement 1511 behave similarly to box 1415 and pop-up advertisement 1417 of FIG. 14. The advertiser 109 has also placed an exemplary advertisement 1503 within the video 1501, so that the exemplary advertisement 1503 may appear as a part of the video 1501. A box 1505 is shown over the exemplary advertisement 1503 that follows the item related to the advertisement in the video, and if a user 107 selects the box 1505, a pop-up advertisement 1507 is displayed. Selection may occur if the user 107 clicks within the box 1505 with a mouse, or if the user 107 moves a cursor within the box 1505, or if the user 107 touches a finger or stylus within the box 1505. The pop-up advertisement 1507 displays information relevant to the exemplary advertisement 1503. In an embodiment, the user 107 may make a second selection within the box 1505, within the pop-up advertisement 1507, or within the exemplary advertisement 1503, and the item displayed in the box 1505 or specified in the exemplary advertisement 1503 may be added to the user's 107 virtual shopping cart, or the user 107 may be redirected to one or more checkout screens to complete a purchase of the exemplary advertisement 1503. The selection may occur if the user 107 clicks on the pop-up advertisement 1505 with a mouse, if the user 107 touches the pop-up advertisement 1507 with a finger or stylus, if the user 107 clicks on the exemplary advertisement 1505, or if the user 107 makes a second selection within the box 1505.

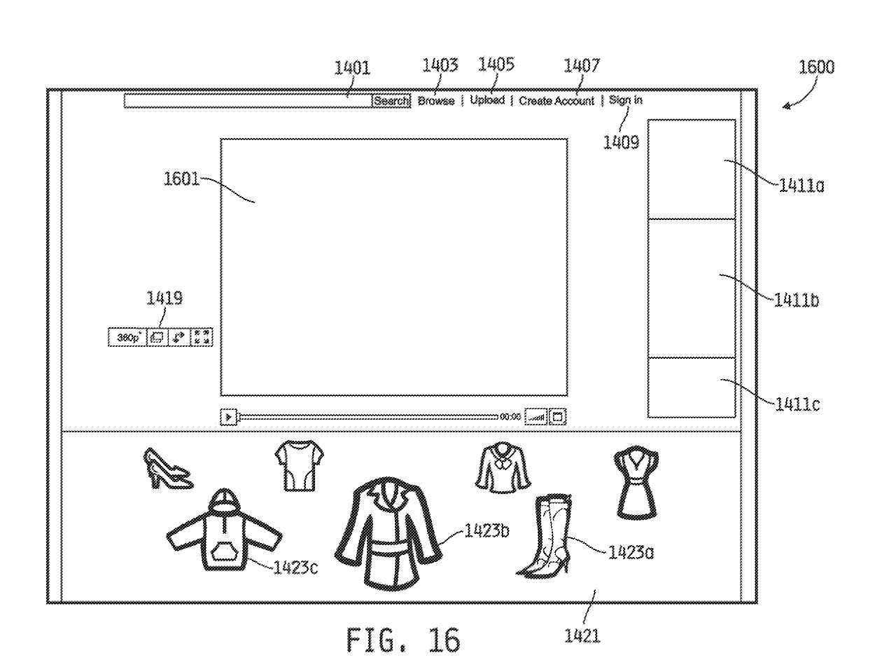

FIG. 16 shows a screen 1600 with an exemplary advertisement overlaid on an exemplary video according to an embodiment of the present disclosure. In an embodiment, if the user 107 selects a pop-up advertisement or makes a selection within a box, the user 107 is redirected to an advertisement 1601 that may explain the pop-up advertisement.

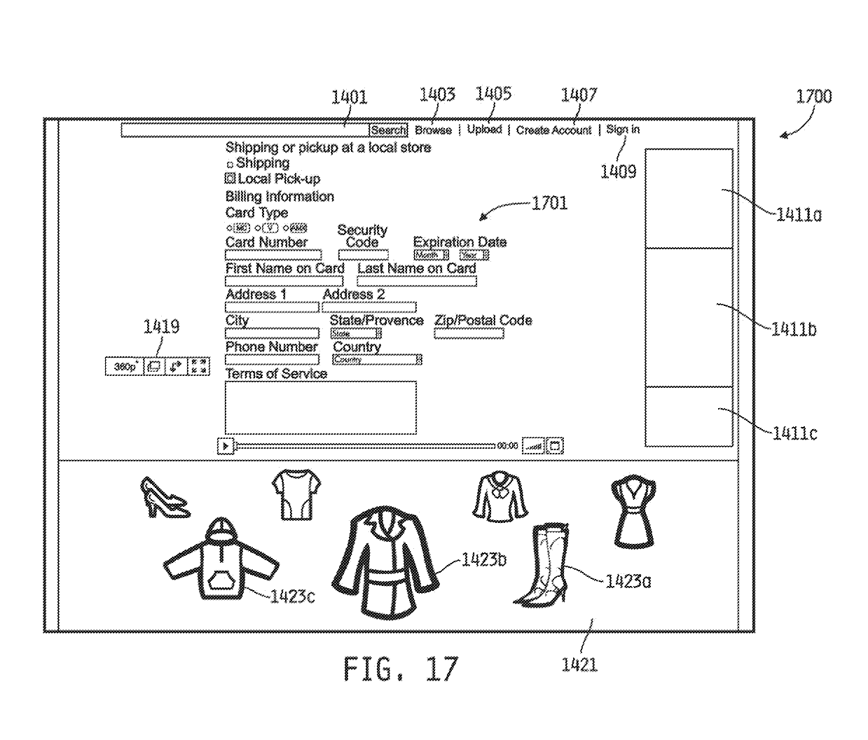

FIG. 17 shows an account data entry and purchase screen 1700 with an exemplary checkout 1701 according to an embodiment of the present disclosure. In another embodiment, if the user 107 selects a pop-up advertisement or makes a selection within a box, the user 107 is redirected to a checkout screen 1701. The checkout screen 1701 may include the information necessary for a user 107 to purchase and receive the item that the user 107 selected. In an embodiment, some or all of the information that the user 107 provides to the checkout screen 1701 is stored within the relationship database 221, and the publishing system 101 populates the information from the relationship database 221 to the checkout screen 1701. The user 107 may change the information populated by the publishing system 101, or may add additional information not populated by the publishing system 101, and the publishing system 101 may receive the updated information and may change the user's 107 information in the relationship database 221 accordingly.

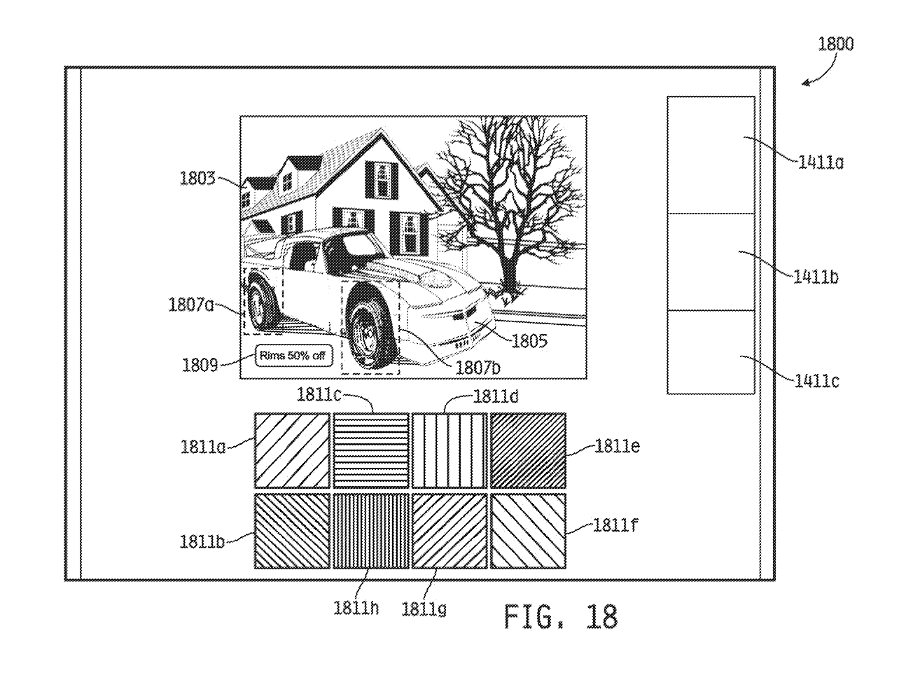

FIG. 18 shows a screen 1800 with an exemplary video with an advertisement overlaid on the video 1803 and a selector to change the color of a product 1805 in the video 1803 according to an embodiment of the present disclosure. In the exemplary screen, either box 1807a or box 1807b displays pop-up advertisement 1809, which may operate similar to the box and pop-up advertisement in FIG. 14. The advertiser 109 may wish to allow a user 107 to choose a color or style of a product 1805 displayed in an advertisement. The advertiser 109 may define, for example, one or more colors 1811a-1811h. If a user 107 selects one of the colors 1811a-1811h, the product 1805 may change to the color selected, or the style of the product 1805 may change according to the selection. Selection may occur if the user 107 clicks within the colors 1811a-1811h with a mouse, or if the user 107 moves a cursor within the colors 1811a-1811h, or if the user 107 touches a finger or stylus within the colors 1811a-1811h.

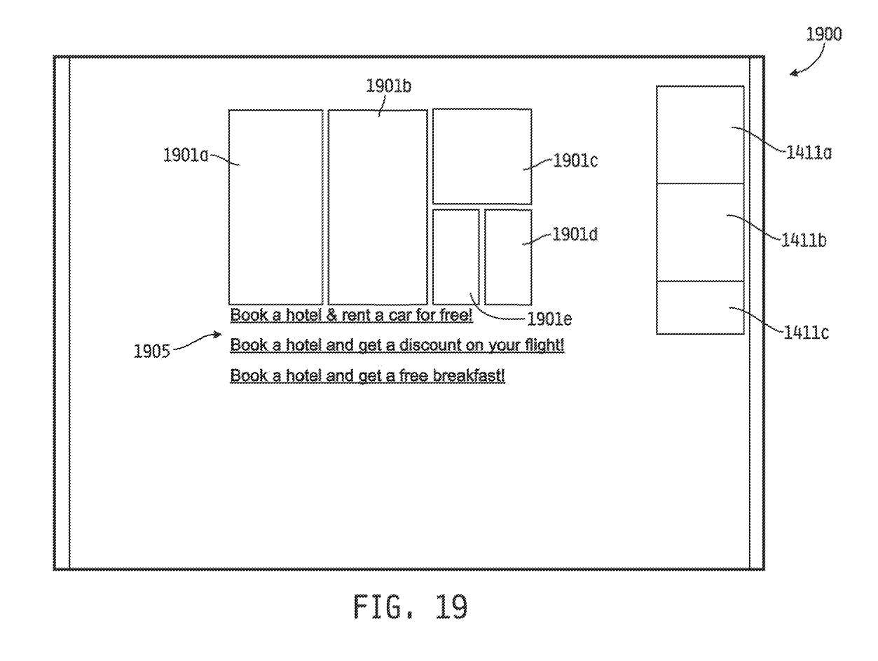

FIG. 19 shows a screen 1900 with an exemplary slideshow with embedded advertisements according to an embodiment of the present disclosure. Instead of a video or other content, a user 107, an advertiser 109, or an advertising company 111 may upload or make available a series of one or more images. The publishing system 101 may provide tools that allow the series of images to be provided to the user 107 in the form of a slideshow, or an aggregation of the images displayed on a web page. For example, a user 107, an advertiser 109, or an advertising company 111 may upload images 1901a-1901e to the publishing system 101. The publishing system 101 may aggregate the images according to the preferences of the user 107, advertiser 109, or advertising company 111 on a single web page, or may create a slideshow that changes images. The change may occur if a user 107 clicks or selects an image, or the change may occur on a timed basis. The time may be changed by the user 107, may be set in the user's 107 preferences, or may be provided by the advertiser 109, advertising company 111, or may be specified in the publishing system 101. Additional links 1905 may be provided to allow a user 107 to select one or more options and proceed to a checkout screen.

FIG. 20 shows an exemplary screen 2000 indicating exemplary social media outlets for sharing one or more items of content according to an embodiment of the present disclosure. A user 107 may select one or more of the social media outlets 2001a-2001f, and may be taken to the social media outlet to announce one or more items of content.

In additional embodiments, other features may also be included. The examples listed are not intended to be limiting. For example, a three-dimensional view of a store or other scene may be displayed to allow a user 107 to select the items to view and purchase. For example, the user 107 enters a site that appears as a Hollywood film studio and may be allowed to virtually walk around the studio, navigating and selecting items to view and/or purchase. Other scenes may be provided, that match the style of items sold in the virtual room. In an embodiment, a virtual assistant may request information from the user 107 and provide suggestions for products or items to purchase and/or view. In another embodiment, a television corner may be provided showing a person, such as an actor, advertising different products, as in a television commercial. Advertisers 109 may use this service without uploading content, and a search tool may allow the users to search for different advertisements based on, for example and without limitation, items or other selection criteria. In another embodiment, advertisers 109 may request that an advertising agency produce content to highlight one or more items. In another embodiment, users may form independent groups, such as social media groups, and get offers for specific products by uploading a video or other content with their specific requests. For example, an advertiser 109 may post a deal for 50% off of a particular item, but if a group of, for example, 200 or more people come together and register, or spread the deal on social media, then the deal may increase to, for example, 65% off of the particular item, or deals for additional items may be offered. In another embodiment, advertising agencies or other individuals such as photographers, producers, editors, musicians, or advertising companies 111 may be approached through the publishing system 101 to provide offers to produce content. In an embodiment, a user 107 may be able to guess statistics of the publishing system 101, and may receive rewards based on the guess. For example, a user 107 may guess how many purchases a certain item will be made in a given period of time, or which advertiser 109 will sell the most items. A user 107 who guesses correctly, or is closest, may receive a prize in the form of, for example, a rebate. Users who refer friends to the publishing system 101 over a given time period may also receive rewards. Rewards may also be available for users who create content of themselves buying or using an item. In an embodiment, a help center may be provided to guide users or advertisers 109 on the use of the publishing system 101 or on content editing techniques. Online consultations with experts may also be available, and a tour video or other interactive guide may be available to users and/or advertisers 109. In an embodiment, users may upload content of items by advertisers 109. If other users view the content and purchase the item, the user 107 who provided the content may receive a reward. The reward may be in the form of a refund on the users' next purchase, or a refund a portion of the purchase price of an item or items already purchased.

In an embodiment, one or more contests are provided that allow users to display content, and allow other participants to view the content and vote on winners. The winners may win compensation or another type of prize based on, for example and without limitation, views, participants' interaction with the content, or purchases originating from or attributed to the content. Voters may be registered with the publishing system 101 by providing, for example and without limitation, full name, e-mail, cell phone, age, address and answer the question if they wish to get e-mails or SMS text messages with the newest videos or other updates, and chose their categories of interest. In an embodiment, the voters may receive more votes, or votes of a greater weight, depending on the type, amount, and/or quality of the information they submit to register as voters. For example, a voter who registers using a full name, address, and email address may have a stronger vote than a voter who registers using only an email address. The voters may comprise a “jury,” that votes on the winner of the contest.

In the embodiment, the contest is advertised with one or more subjects and/or categories to be included in the movie, for example: a restaurant, cloth, baby's products, a spa, a hotel etc. The rules are published and, in the embodiment, the jury will have a weight of 50% of the final decision regarding the winners. The participants have a set period of time to upload their videos, which may be set by the rules. In an embodiment, the contest is open-ended, and may be ended by another criteria. The user 107 or other content provider may upload content to the advertising system and may be asked to provide additional identifying information and/or agree to terms and conditions. In an embodiment, the user 107 or other content provider may associate the uploaded content with other social media systems or content, such as profiles. In an embodiment, the jury approves content to allow the content to participate in the contest.

The publishing system 101 receives the content and, in an embodiment, shows the content to prospective companies, publishers and/or other deal systems. In an embodiment, the content is shown to potential publishers, and then they are prevented from voting. In another embodiment, the content is described to the potential publishers, and is shown to the potential publishers at a later date. The content publishers decide to advertise one or more products in content, and the selection may be finalized before the voting process.

During the time period for submission, the publishing system 101 checks the content, closes deals, which may be, for example and without limitation, items and/or coupons, with the potential publishers, and the jury may begin to vote for the final decision. In an example, the time period for submission is one month. An additional time period may be provided for administration and for adding information regarding the deals.

After the time period for submission, in the example approximately six weeks after the start of the contest, participants are notified by, for example and without limitation, email or other contact mechanism, and the participants are notified that they can send links, collect “likes” and “share” their video from the publishing system 101 on content or other social media platforms. The participants can market their content to drive other users to the publishing system 101, where they may vote. The voting process may occur during a time window; in the example, the voting window is approximately two weeks. During this time the jury will watch content and choose the best ones. In an embodiment, the participants may be prohibited from publishing the content elsewhere for a period of time during or after the contest.

Advertisers can add their deals during this period of time as well. Each item for sale may have an image and/or logo of the advertiser beside the content, so the viewers will know what is for sale. Clicking on the logos and/or images may also take viewers to their shopping cart.

After a period of time, in the example approximately eight weeks after the start of the contest, the winners may be declared. Winners may be declared according to views of the content, the number of items or the amount of sales generated by the content, the number of viewers that viewed items featured in the content, or by another criteria. Reward ceremonies may be filmed and displayed or archived.

In an embodiment, the content that is uploaded to the publishing system 101 will not be displayed before approval and/or an attempt is made to sell a deal with the content. In an embodiment, the participants are notified that the administrators may have a time period to allow the content or deny it. In an embodiment, the time period is one week. In an embodiment, publishers may upload their TV commercials and successful videos to the publishing system 101 and attach a deal and/or coupon. In an embodiment, the publishing system 101 adds a code or other unique identifier to the content so that whoever adds or implements it in another system, such as a social media platform or other media platform, the viewing of the content drives more traffic to the publishing system 101, and the user may become an affiliate. In an embodiment, other content providers may also implement the codes or other unique identifiers, and also become affiliates. In an embodiment, participants are rewarded with prizes when their content sells products. Rewards may be offered at milestones, for example five or ten units, or on a per unit basis. In an embodiment, existing users of the publishing system 101 may recommend others to join, and may receive rewards based on the number of other users that the existing user invites to join. In an embodiment, the user's profiles combine with the user's other profiles on other social media or other media distribution systems. In an embodiment, a private channel with no deals may also be present. In the embodiment, the private channel may be offered for a fee, such as a monthly payment. In an embodiment, a free or no-fee private channel may be offered, with a deal and/or sharing model.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains.

What is claimed is:

1. A publishing system, comprising:
a module operable to receive and store one or more items of content;
a module operable to embed one or more activation zones and associate one or more items with the content and the activation zones as association data;
a module to transmit the content and the association data to a client;
a module to receive purchase requests from the client and activate a checkout process; and
a module to generate statistical information regarding a user's interaction with the content.

2. The publishing system of claim 1, wherein the one or more items of content is in the form of a video file, and the association data is embedded within the video file.

3. The publishing system of claim 1, wherein the activation zones move in the video file with the content when the video file is played.

4. The publishing system of claim 1, further comprising a module for generating and transmitting a checkout screen, where the checkout screen is transmitted upon receipt of a purchase request.

5. The publishing system of claim 1, wherein the purchase requests are associated with one of the activation zones.

6. The publishing system of claim 1, wherein the one or more items of content is in the form of one or more images transmitted to the client as a slideshow.

7. The publishing system of claim 1, further comprising a module to create representations of one or more products, and embed the representations within the one or more items of content.

8. The publishing system of claim 1, further comprising a portal available to advertisers to create and edit the one or more items of content.

9. The publishing system of claim 1, further comprising a module to transmit information regarding one or more of the one or more items of content to a social networking system.

10. A publishing system, comprising:
a portal available to advertisers to create and edit the one or more items of content;
a module operable to receive and store one or more items of content transmitted from the portal;
a module operable to embed one or more activation zones and associate one or more items with the content and the activation zones as association data;
a module to transmit the content and the association data to a client;
a module to receive purchase requests from the client and activate a checkout process;
a module to generate statistical information regarding a user's interaction with the content; and
a module to transmit information regarding one or more of the one or more items of content to a social networking system.

11. The publishing system of claim 10, wherein the content is in the form of a video file, and the association data is embedded within the video file.

12. The publishing system of claim 10, wherein the content is in the form of one or more images transmitted to the client as a slideshow.

13. A method of creating content with embedded advertisements, comprising:
creating content;
receiving tools to embed advertisements within the content;
creating one or more activation zones within the content;
linking each of the one or more activation zones to at least one product in at least one link; linking the one or more activation zones with a checkout system, wherein the activation zones and the links to the at least one product and the one or more checkout systems comprise association data; and
providing the content and the association data to a publishing system.

14. The method of claim 13, wherein the content is in the form of a video file, and the association data is embedded within the video file.

15. The method of claim 13, wherein the content is in the form of one or more images transmitted to the client as a slideshow.

16. A method of advertising products in content, comprising:
receiving content with one or more activation zones, wherein each of the activation zones include at link to at least one product identifier, wherein the product identifiers identify at least one product;
transmitting the content to a client;
receiving a purchase request from the client with one or more product identifiers;
transmitting a checkout screen to the client, the checkout screen indicating a purchase of at least one product associated with the one or more product identifiers; and
transmitting purchase information to an advertiser associated with the product associated with the one or more product identifiers.

17. The method of claim 16, wherein the content is in the form of a video file, and the association data is embedded within the video file.

18. The method of claim 16, wherein the content is in the form of one or more images transmitted to the client as a slideshow.
